(19) United States
(12) Patent Application Publication
(10) Pub. No.: US 2012/0190760 A1
(43) Pub. Date: Jul. 26, 2012

(54) SILICONE-POLYETHER BLOCK COPOLYMERS WITH HIGH MOLECULAR WEIGHT POLYETHER RESIDUES AND THEIR USE AS STABILIZERS FOR PRODUCTION OF POLYURETHANE FOAMS

(75) Inventors: Frauke Henning, Essen (DE); Annegret Terheiden, Alpen (DE); Roland Hubel, Essen (DE); Sarah Schmitz, Essen (DE); Carsten Schiller, Muelheim an der Ruhr (DE); Frank Schubert, Neukirchen-Vluyn (DE)

(73) Assignee: EVONIK GOLDSCHMIDT GMBH, Essen (DE)

(21) Appl. No.: 13/358,142

(22) Filed: Jan. 25, 2012

(30) Foreign Application Priority Data
Jan. 26, 2011 (DE) DE102011003150.2

(51) Int. Cl. C08L 83/12; C08G 77/46

(52) U.S. Cl. 521/86; 528/33; 524/588; 523/122

(57) ABSTRACT

Silicone-polyether block copolymer comprising a polyorganosiloxane which includes at least one polyether residue having a molecular weight of not less than 5000 g/mol, and wherein a weight average molecular weight of all polyether residues attached to the polyorganosiloxane by a chemical bond is above 3000 g/mol, its production and use and also compositions and polymeric articles obtained therewith.

### FIELD OF THE INVENTION

The present invention relates to a silicone-polyether block copolymer comprising a polyorganosiloxane comprising at least one polyether residue having a molecular weight of not less than 5000 g/mol and wherein a weight average molecular weight of all polyether residues attached to the polyorganosiloxane by a chemical bond is above 3000 g/mol. The present invention also relates to the production and use of the silicone-polyether block copolymer as well as compositions and polymeric articles such as, for example, polyurethane foam articles, obtained therewith.

### BACKGROUND OF THE INVENTION

Polyurethanes of various kinds are obtained by the polymerization of diisocyanates such as 4,4′-methylenebis(phenyl isocyanate), MDI for short, or 2,4-tolylene diisocyanate, TDI for short, with polyether polyols or polyester polyols. The polyether polyols are obtained by the alkoxylation of polyhydroxy-functional precursors such as, for example, glycols, glycerol, trimethylolpropane, pentaerythritol, sorbitol or sucrose. Polyurethane foams are produced using additional blowing agents, for example, pentane, acetone, methylene chloride or carbon dioxide. An indispensable corequisite for reproducible industrial manufacture of foam parts is using a surfactant to stabilize the polyurethane foam. Apart from the few purely organic surfactants, silicone surfactants are mostly used because of their higher interface stabilization potential.

A multiplicity of different polyurethane foams, for example, hot-cure flexible foam, cold-cure foam, ester foam, rigid PUR foam and rigid PIR foam are known. The stabilizers used have been specifically developed to match the particular end use, and typically give a distinctly altered performance if used in the production of other types of foam.

Rigid polyurethane and polyisocyanurate foams are produced using cell-stabilizing additives so that a fine-celled, uniform and low-defect structure may be obtained for the foam and thereby to exert a significant positive influence on the performance characteristics—particularly the thermal insulatability—of the rigid foam. Again, surfactants based on polyether-modified siloxanes are particularly effective and therefore constitute the preferred type of cell stabilizer. Since there are a multiplicity of different rigid foam formulations for different fields of application that impose individual requirements on the cell stabilizer, polyether siloxanes of differing structure are used. For instance, the choice of a blowing agent has influenced the development of new, optimized stabilizers. While EP 0 570 174 A1 still describes the production of rigid polyurethane foam using chlorofluorocarbons, the development in the field proceeds via purely fluorinated hydrocarbon blowing agents as described in EP 0 533 202 A1 to the current standard blowing agent pentane, as described in EP 1 544 235 A1.

Flexible polyurethane foams are frequently obtained using carbon dioxide as an environmentally friendly blowing agent. EP 0 797 606 A1 and EP 1 501 889 A1 describe the stabilizers customary for this use. However, methylene chloride continues to be used as blowing agent in countries having less strict environmental regulations. EP 0 694 585 A2 describes stabilizers used in this case.

In the prior art, the polysiloxane-polyoxyalkylene block copolymers used for polyurethane foam stabilization are frequently obtained through noble metal-catalyzed hydrosilylation of unsaturated polyoxyalkylenes having SiH-functional siloxanes, i.e., hydrosiloxanes, as described, for example, in EP 1 520 870. The hydrosilylation can be carried out batchwise or continuously as described, for example, in DE 198 59 759 C1.

Hot-cure flexible polyurethane foam stabilizers are usually obtained using allyl polyethers in the hydrosilylation that are not hydroxy-functional. In fact, the allyl polyethers are so-called endcapped polyethers, the hydroxy-functional end of which is transformed into a methyl ether group or a carboxylic ester group in a subsequent reaction. It is also common to employ polyether mixtures made up of specifically defined individual polyethers having precisely bounded properties in respect of molar mass and polarity.

EP 0 600 261 for instance describes polysiloxane-polyoxyalkylene block copolymers having different polyoxyalkylene blocks in the average molecule and used as stabilizers for the production of flexible polyurethane foams. EPA 0 600 261 goes into very precise detail with regard to the composition of the polyoxyalkylene moieties represented in the average silicone-polyether copolymer in terms of their average molecular weights, their ethylene oxide/propylene oxide ratio and their individual, percentage proportion in the overall matrix of adducted polyethers.

EP 0 585 771 A2 reveals that the polysiloxane-polyoxyalkylene block copolymers which constitute particularly effective foam stabilizers are characterized by a merely empirically determinable combination of hydroxy-functional and endcapped polyoxyalkylene blocks of differing molecular weight and differing hydrophilicity/lipophilicity. It is only a fine-tuned ratio of hydrophilic, lipophilic and siliconophilic polymer blocks that endows the stabilizer in the particular use with its optimum performance. Experience teaches that when the hydrophilic, lipophilic and siliconophilic proportions in the polysiloxane-polyoxyalkylene block copolymer vary in response to variations in the raw materials, the compatibilization of the foam stabilizer with the reacting polyurethane matrix can be worse, which can hinder homogeneous distribution of the surfactant and its subsequent migration to the interface in such a way that a foam collapse is the direct consequence.

A multiplicity of further documents, such as EP 0 493 836 A1, U.S. Pat. No. 5,565,194 or EP 1 350 804 for example, disclose specifically assembled polysiloxane-polyoxyalkylene block copolymers to achieve specific profiles of requirements for foam stabilizers in diverse polyurethane foam formulations. To obtain the respective stabilizers involved, the hydrosilylation utilizes mixtures of two or three preferably endcapped allyl polyethers having molecular weights less than 6000 g/mol and preferably less than 5500 g/mol. Polyethers with molecular weights above 5500 g/mol are not readily obtainable via alkaline alkoxylation, since secondary reactions that promote chain termination dominate with increasing chain length.

As explained in U.S. Pat. Nos. 5,856,369 and 5,877,268, it is the high chemical purity and the high molar mass combined with low polydispersity which causes the unsaturated polyetherols obtained via DMC catalysts to give polyurethane foam stabilizers of high activity. However, the usefulness of the polyetherols described, which are usually started on allyl alcohol, in the field of PU foam stabilizers is limited to a relatively small group of polyetherols that consists of ethylene oxide and propylene oxide monomer units in partly randomly mixed sequence and in which the ethylene oxide fraction does not exceed 60 mol % in order that the formation of polyethylene glycol blocks in the polymer chain may be avoided. The solubility and hence the efficaciousness of the aforementioned stabilizers are substantially limited in formulations with hydrophilic polyols. In addition to universal utility in various formulations, processing latitude is also an important factor governing the usefulness of a stabilizer. A wide processing latitude means that foam properties remain constant in the event of dosage fluctuations for the starting materials. Processing latitude can be determined by varying the use levels of the stabilizer and the catalyst. As one skilled in the art knows, high-activity stabilizers, for example the silicone-polyether copolymers described in U.S. Pat. Nos. 5,856,369 and 5,877,268, usually have too little processing latitude. U.S. Pat. No. 5,856,369, U.S. Pat. No. 5,877,268 and EP 0 712 884 show that the use of particularly long-chain polyethers in the polyoxyalkylene moiety of the silicone-polyether copolymer leads to more viscous products which first have to be diluted with solvents in order that normal handling may be ensured. The aforementioned publications further mention the parameter of the blend average molecular weight of the polyether mixture, which is less than 3000 g/mol and preferably even below 2000 g/mol in order that excessively high viscosities may be avoided and open-cell polyurethane foams may be ensured. The low blend average molecular weights mentioned are evidently attributable to the comparatively low fractions in the blend of allyl polyethers having molecular weights above 5500 g/mol.

Polyurethane foam formulations having low densities have high requirements in respect of the activity of the stabilizer and also in respect of its cell-refining and cell-opening properties. As known to those skilled in the art, the aforementioned two contrary properties are usually only combinable with each other to a certain extent. U.S. Patent Application Publication No. 2009-0253817 A1 describes the use of silicone-polyether copolymers whose polyether mixture consists of three individual polyethers, namely two endcapped allyl polyethers with average to low molecular weights in the range from 800 g/mol to not more than 5500 g/mol and a hydroxy-functional allyl polyether having a molecular weight of 1400 g/mol to 2300 g/mol. As reference examples 2.1 and 2.2 in the '817 publication show, the high activity of these stabilizers is associated with reductions in open-cell content.

Patent Application CN 101099926 A describes endcapped nonionic surfactants and their use in an undisclosed polyurethane foam formulation used to produce foams of medium or low density. Although the use of endcapped polyethers having molecular weights up to 9500 g/mol is mentioned as an in-principle possibility in the description, the disclosed examples merely describe the use of methylated allyl polyethers having molecular weights of 1000 to 4500 g/mol. As reference examples 2.3 and 2.4 in the '926 Chinese Application show, the stabilizers disclosed therein have disadvantages which, in low-density foams, either lead to coarse cell structure or, because of the absence of stabilizing properties, directly to foam collapse.

### SUMMARY OF THE INVENTION

In view of the prior art, the problem addressed by the present invention is that of providing universally usable silicone-polyether block copolymers having a balanced profile of properties in respect of polyurethane foam stabilization and cell regulation, the performance capability of which is comparable to that of established silicone-polyether copolymers and even superior thereto in formulations of low foam density.

This problem is surprisingly solved by the silicone-polyether block copolymers of the present invention.

The present invention accordingly provides silicone-polyether block copolymers comprising a polyorganosiloxane comprising at least one polyether residue having a weight average molecular weight of not less than 5000 g/mol and wherein a weight average molecular weight of all polyether residues attached to the polyorganosiloxane by a chemical bond is above 3000 g/mol, and also a process for production thereof.

The present invention also provides compositions containing one or more silicone-polyether copolymers of the present invention, the use of a silicone-polyether block copolymer of the present invention, or of a composition of the present invention, in the production of polyurethane foams, and also polyurethane foams obtained using a silicone-polyether block copolymer of the present invention and articles containing or consisting of this polyurethane foam of the present invention.

The copolymers of the present invention have the advantage of being simply made from allyl polyethers obtained via DMC catalysis, and so only a small proportion of propenyl polyether is present in the copolymers of the present invention.

The silicone-polyether block copolymers of the present invention have the advantage of being high-activity polyurethane foam stabilizers which ensure good foam stabilization and cell fineness even at low use levels. When the long-chain polyethers are obtained via double metal cyanide catalysts, the silicone-polyether block copolymers of the present invention further have the advantage of being economical to produce, since there is no need for the costly and inconvenient neutralization of the polyether after the alkoxylation.

The silicone-polyether block copolymers of the present invention further have the advantage of being useful, at low use level, for production of fine- and open-cell hot-cure flexible and rigid polyurethane foams having very low to medium densities.

The copolymers of the present invention also have the advantage that the polyether residues have a low polydispersity, preferably Mw/Mn<=1.5. Fluctuations in the stabilizer synthesis and in the stabilizer properties themselves can be minimized as a result.

The use of silicone-polyether block copolymers of the present invention leads to polyurethane foams which are lightweight and yet fine-celled. Foams of low density are useful for example as lightweight packaging materials for protection of impact- or scratch-sensitive high-value goods which, for transportation, are wrapped with such a packaging foam for cushioning.

### DETAILED DESCRIPTION OF THE INVENTION

The silicone-polyether block copolymers of the present invention and their use will now be described by way of example without any intention to restrict the invention to these exemplary embodiments. Where ranges, general formulae or classes of compounds are indicated in what follows, they shall encompass not just the corresponding ranges or groups of compounds that are explicitly mentioned, but also all sub-ranges and sub-groups of compounds which are obtainable by extraction of individual values (ranges) or compounds. Where documents are cited in the context of the present description, their content shall fully belong to the disclosure content of the present invention. Percentages are by weight, unless otherwise stated. Averages reported hereinbelow are by weight, unless otherwise stated.

The hereinbelow indicated weight average molecular weight of all polyether residues attached to the polyorganosiloxane by a chemical bond—MW_{blend}—is defined as the sum total of the products formed from the molar fractions of the respective polyether residue in the blend, fₘₒₗₐᵣ, and its individual weight average molecular weight, Mw_{poiyether}. (formula X)

Mw_{blend}=Σ[fₘₒₗₐᵣ×MW_{polyether}] Formula X

The silicone-polyether block copolymers of the present invention comprise a polyorganosiloxane which includes at least one polyether residue and are characterized in that each silicone-polyether block copolymer molecule contains on average at least one polyether residue having a weight average molecular weight of not less than 5000 g/mol, preferably not less than 5500 g/mol and more preferably not less than 6000 g/mol, and in that the weight average molecular weight of all polyether residues reacted with the polyorganosiloxane and attached to the polyorganosiloxane by a chemical bond is above 3000 g/mol and preferably above 3500 g/mol.

Preferably, in the silicone-polyether block copolymers of the present invention, at least one polyether residue having a weight average molecular weight of not less than 5000 g/mol and preferably not less than 6000 g/mol and at least one polyether residue having a weight average molecular weight of below 5000 g/mol and preferably below 4500 g/mol are attached to the polyorganosiloxane by a chemical bond.

In preferred silicone-polyether block copolymers of the present invention, the weight average molecular weight of all polyether residues attached to the polyorganosiloxane by chemical bond is above 3000 g/mol and below 5000 g/mol.

The silicone-polyether block copolymers of the present invention preferably conform to formula (I):

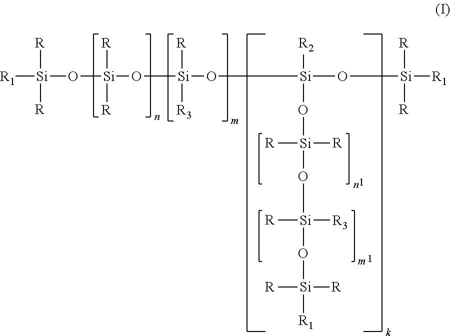

where
n and n¹ are each independently from 0 to 500, preferably 10 to 200 and more particularly 15 to 100 and (n+n¹) is <500, preferably <200 and more particularly <100,
m and m¹ are each independently from 0 to 60, preferably 0 to 30 and more particularly 0.1 to 25 and (m+m¹) is <60, preferably <30 and more particularly <25,
k is from 0 to 50, preferably from 0 to 10 and more particularly 0 or from 1 to 5,
R represents alike or unalike radicals selected from linear, cyclic or branched, aliphatic or aromatic, saturated or unsaturated hydrocarbon radicals having from 1 up to 20 carbon atoms,

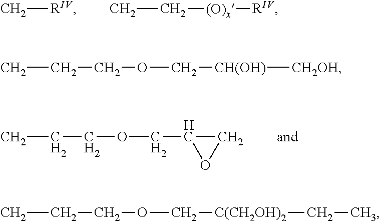

where
x′ is 0 or 1 and
R^{IV} is an optionally substituted, optionally halogen-substituted hydrocarbon radical having 1 to 50 carbon atoms,
wherein R is preferably a methyl radical, wherein all R radicals are more preferably methyl radicals,
R₁ is R or R₃,
R₂ is R or R₃ or a heteroatom-substituted, functional, organic, saturated or unsaturated radical, preferably selected from the group of alkyl, chloroalkyl, chloroaryl, fluoroalkyl, cyanoalkyl, acryloyloxyaryl, acryloyloxyalkyl, methacryloyloxyalkyl, methacryloyloxypropyl or vinyl radicals, more preferably is a methyl, chloropropyl, vinyl or methacryloyloxypropyl radical,
R₃ is -Q-O—(CH₂—CH₂O—)ₓ—(CH₂—CH(R′)O—)_{y}—(SO)_{z}—R″
or
-Q-O—(CH₂—CH₂O—)ₓ—(CH₂—CH(R′)O—)_{y}—R″,
where
Q=divalent hydrocarbon radical having 2 to 4 carbon atoms, preferably
Q=-CH₂—CH₂—CH₂— or —CH₂—CH₂—
x=0 to 200, preferably from 10 to 100,
y=0 to 200, preferably from 10 to 100,
z=0 to 100, preferably from 0 to 10,
R′ is an alkyl or aryl group which has altogether 1 to 12 carbon atoms, preferably methyl or ethyl, more preferably methyl, and is unsubstituted or optionally substituted, for example with alkyl radicals, aryl radicals or haloalkyl or haloaryl radicals, and
R″ is a hydrogen radical or an alkyl group having 1 to 4 carbon atoms, a —C(O)—R′″ group where R′″=alkyl, a —CH₂—O—R′ group, an alkylaryl group, e.g. benzyl group, the —C(O)NH—R′ group, the C(O)—OR′ group, preferably a hydrogen radical or a methyl or acetyl radical,
SO is a styrene oxide radical —CH(C₆H₅)—CH₂—O—,
with the proviso that at least one radical is an R₃ radical and that at least one R₃ radical is a polyether residue having a weight average molecular weight not less than 5000 g/mol and the weight average molecular weight MW according to formula (X) of all polyether residues R₃ in the copolymer of formula (I) is more than 3000 g/mol, and n+n¹+m+m¹ is not less than 10, preferably 15 and more preferably not less than 20.

The various monomer units of the polyorganosiloxane chain and also of the polyoxyalkylene chain can each have a blockwise construction or form a random distribution. The index numbers shown in the formulae recited herein and the value ranges for the indicated indices are therefore to be understood as the average values of the possible statistical distribution of the actually isolated structures and/or mixtures thereof.

It can be advantageous when R″ is hydrogen in all polyether residues R₃ having a weight average molecular weight not less than 5000 g/mol. It can also be advantageous when R″ is other than hydrogen in all polyether residues R₃ having a weight average molecular weight below 5000 g/mol. Preferably R″ is hydrogen in all polyether residues R₃ having a weight average molecular weight not less than 5000 g/mol and other than hydrogen in all polyether residues R₃ having a weight average molecular weight below 5000 g/mol. It will be readily understood that technical grade products having purities below 100% may contain minor fractions of process-inherent by-products, and that the chemical yields are >90% ideally >98% but frequently not exactly 100%. Endcapped polyethers may thus contain small fractions of the hydroxy-functional precursors/intermediates.

The silicone-polyether block copolymers of the present invention are obtainable by organomodification of branched or linear polyorganosiloxanes having terminal and/or lateral SiH functions, with a polyether or polyether mixture of two or more polyethers, characterized in that the polyether or polyether mixture used is or contains at least one polyether having a weight average molecular weight not less than 5000 g/mol and the average molecular weight MW as per formula (X) of all polyethers used is above 3000 g/mol, wherein preference is given to using such polyethers which contain and end group which contains a vinyl end group and which is more particularly an allyl group.

The silicone-polyether block copolymers of the present invention are obtainable in various ways using process steps known from the prior art.

The process of the present invention for producing silicone-polyether block copolymers comprises branched or linear polyorganosiloxanes having terminal and/or lateral SiH functions reacted with a polyether or a polyether mixture of two or more polyethers and is characterized in that the polyether used or the polyether mixture used is or contains at least one polyether having a weight average molecular weight not less than 4999 g/mol, preferably 5999 g/mol and preferably 6999 g/mol and in that the average molecular weight of all polyethers used is above 2999 g/mol and preferably above 3499 g/mol. The polyethers used are preferably polyethers containing an end group which contains a vinyl end group and is more particularly an allyl group.

The reaction is preferably carried out as noble metal-catalysed hydrosilylation, preferably as described in EP 1 520 870.

The process of the present invention preferably utilizes polyorganosiloxanes having terminal and/or lateral SiH functions, of formula (II)

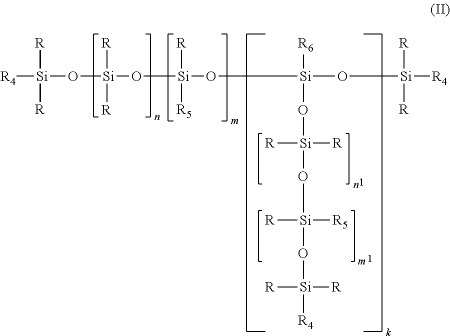

where
n and n¹ are each independently from 0 to 500, preferably from 10 to 200 and more particularly from 15 to 100 and (n+n¹) is <500, preferably <200 and more particularly <100, m and m¹ are each independently from 0 to 60, preferably from 0 to 30 and more particularly from 0.1 to 25 and (m+m¹) is <60, preferably <30 and more particularly <25, k=0 to 50, preferably from 0 to 10 and more particularly 0 or from 1 to 5,
R is as defined above,
R₄ in each occurrence independently is hydrogen or R,
R₅ in each occurrence independently is hydrogen or R,
R₆ in each occurrence independently is hydrogen, R or a heteroatom-substituted, functional, organic, saturated or unsaturated radical, preferably selected from the group of alkyl, chloroalkyl, chloroaryl, fluoroalkyl, cyanoalkyl, acryloyloxyaryl, acryloyloxyalkyl, methacryloyloxyalkyl, methacryloyloxypropyl or vinyl radicals and more preferably is a methyl, chloropropyl, vinyl or methacryloyloxypropyl radical, with the proviso that at least one of R₄, R₅ and R₆ is hydrogen.

The polyorganosiloxanes having terminal and/or lateral SiH functions of formula (II), which are used to form the polysiloxane-polyoxyalkylene block copolymers, are obtainable as described, for example, in EP 1439200 B1 and DE 10 2007 055485 A1.

The unsaturated polyoxyalkylenes used (polyethers having a vinyl end group and more particularly an allyl end group) are obtainable by the literature method of alkaline alkoxylation of a vinyl-containing alcohol, especially allyl alcohol, or by using DMC catalysts as described, for example, in DE 10 2007 057145 A1.

Preferably employed unsaturated polyoxyalkylenes are of formula (III)

Q′-O—(CH₂—CH₂O—)ₓ—(CH₂—CH(R′)O—)_{y}—(SO)_{z}—R″ (III)
Q′=CH₂═CH—CH₂— or CH₂═CH— and SO, R′, R″, x, y and z are each as defined above, with the proviso that the sum total of x+y+z is other than 0 and preferably is chosen such that the abovementioned weight average molecular weights are obtained.

The silicone-polyether copolymers of the present invention are useful for a wide variety of purposes. More particularly, the silicone-polyether copolymers of the present invention can be used for, or to be more precise, in the production of polyurethanes, more particularly polyurethane foams.

Preferred compositions contain one or more silicone-polyether copolymers of the present invention and are characterized in that the composition further contains one or more substances useful in polyurethane foam production and selected from polyol, nucleating agents, cell-refining additives, cell openers, crosslinkers, emulsifiers, flame retardants, antioxidants, antistats, biocides, color pastes, solid fillers, catalysts, in particular amine catalysts and/or metal catalysts and buffer substances. It can be advantageous when the composition of the present invention contains one or more solvents, preferably selected from glycols, alkoxylates or oils of synthetic and/or natural origin.

The silicone-polyether block copolymers of the present invention or the compositions of the present invention are preferably used in the production of polyurethane foams. The silicone-polyether block copolymer of the present invention is preferably used as a foam stabilizer. The silicone-polyether block copolymers of the present invention, especially those of formula (I) are suitable with particular preference as polyurethane foam stabilizers in the production of, for example, polyurethane flexible foam, hot-cure flexible foam, rigid foam, cold-cure foam, ester foam, viscoelastic flexible foam or else high resilience foam (HR foam), and with very particular preference as polyurethane hot-cure foam stabilizers.

The silicone-polyether block copolymers of the present invention or the compositions of the present invention are preferably used in polyurethane foam production processes using water, methylene chloride, pentane, alkanes, halogenated alkanes, acetone and/or carbon dioxide and preferably water, pentane or carbon dioxide as blowing agents.

The polyurethane foam of the present invention is obtained using a silicone-polyether block copolymer of the present invention. The polyurethane foam of the present invention provides articles which contain or consist of this polyurethane foam. Such articles can be, for example, furniture cushioning, refrigerator insulation, sprayable foams, metal composite elements for (building) insulation, mattresses or auto seats. The lists are to be understood as overlapping and as not-conclusive.

The polyurethane foams of the present invention are obtainable using prior art formulations and procedures.

The subject matter of the present invention is hereinbelow more particularly elucidated using examples without any intention to restrict the subject matter of the invention to these exemplary embodiments.

### EXAMPLES

### Example 1

### Production of Polyether Siloxanes

### Example 1a

### Production of Polyethers

The polyethers were obtained using prior art methods known in the art. The molecular weights Mₙ and M_{w} were determined by gel permeation chromatography under the following conditions of measurement: column combination SDV 1000/10 000 Å (length 65 cm), temperature 30° C., THF as mobile phase, flow rate 1 ml/min, sample concentration 10 g/l, RI detector, evaluation against polypropylene glycol standard.

The following polyethers of formula (III) each with Q=CH₂═CH—CH₂— and R′═—CH₃ were employed:
PE1: R″═H, z=0, x=16, y=12, M_{w}=1459 g/mol
PE2: R″═C(O)—CH₃, z=0, x=16, y=12, M_{w}=1484 g/mol
PE3: R″═C(O)—CH₃, z=0, x=40, y=30, M_{w}=3832 g/mol
PE4: R″═H, z=0, x=57, y=60, Mₙ=5226 g/mol, M_{w}=6872 g/mol
PE5: R″═CH₃, z=0, x=17.7, y=23.6, M_{w}=2206 g/mol
PE6: R″═CH₃, z=0, x=47, y=49, M_{w}=4983 g/mol
PE7: R″═H, z=0, x=78, y=81, Mₙ=7032 g/mol, M_{w}=9871 g/mol
PE8: R″═C(O)—CH₃, z=0, x=10, y=16, M_{w}=1373 g/mol

### Example 1b

### Production of Hydrosiloxanes

The hydrosiloxanes were obtained as described in Example 1 of EP 1439200 B1. The hydrosiloxanes employed were defined as follows in accordance with formula (II):
SIL1: R₄═R═CH₃, R₅═H, k=0, n=70, m=5
SIL2: R₄═R═CH₃, R₅═H, k=0, n=69, m=8
SIL3: R₄═R═CH₃, R₅═H, k=0, n=89, m=6.5
SIL4: R₄═R═CH₃, R₅═H, k=0, n=74, m=4.0

### Example 1c

### Production of Polyether Siloxanes

The polyether siloxanes listed in Table 1 and Table 2 were obtained as described in Example 7 of WO 2009/065644.

TABLE 1
Inventive silicone-polyether block copolymers

| | | | | | | | Appearance |
|---|---|---|---|---|---|---|---|
| Example | | | Weights of individual | | | | of polyether |
| No. | Siloxane | Amount | polyethers used | | | MW_{blend} | siloxane |
| 1.1 | SIL3 | 41.0 g | 11.7 g | 33.4 g | 146.1 g | 3898 | slightly |
| | | | PE2 | PE8 | PE4 | g/mol | cloudy |
| 1.2 | SIL3 | 39.0 g | 11.0 g | 31.4 g | 155.2 g | 4295 | slightly |
| | | | PE2 | PE8 | PE7 | g/mol | cloudy |
| 1.3 | SIL4 | 41.0 g | 127.6 g | 35.6 g | | 4372 | slightly |
| | | | PE7 | PE1 | | g/mol | cloudy |

TABLE 2
Noninventive silicone-polyether block copolymers

| | | | | | | | Appearance |
|---|---|---|---|---|---|---|---|
| Example | | | Weights of individual | | | | of polyether |
| No. | Siloxane | Amount | polyethers used | | | MW_{blend} | siloxane |
| V.1 | SIL1 | 63.2 g | 19.2 g | 62.0 g | 105.6 g | 2264 | clear |
| | | | PE1 | PE2 | PE3 | g/mol | |
| V.2 | SIL1 | 63.2 g | 38.3 g | 42.9 g | 105.6 g | 2258 | clear |
| | | | PE1 | PE2 | PE3 | g/mol | |
| V.3 | SIL2 | 40.0 g | 104.3 g | 138.4 g | — | 3227 | clear |
| | | | PE5 | PE6 | | g/mol | |
| V.4 | SIL2 | 40.0 g | 132.5 g | 74.8 g | — | 2761 | clear |
| | | | PE5 | PE6 | | g/mol | |

### Example 2

### Producing Low-Density Polyurethane Foams

Low-density polyurethane foams were obtained using the following recipe: 100 parts by weight of polyetherol (hydroxyl number=56 mg KOH/g), 11 parts by weight of water, 10 parts by weight of silicone stabilizer (as per Table 3), 0.9 part by weight of a tertiary amine, 140 parts by weight of a tolylene diisocyanate T 80 (Index 122), 90 parts by weight of methylene chloride, and also 1 part by weight of KOSMOS® 29 (Evonik Goldschmidt GmbH).

The amount of poly(ether)ol used in foaming was 80 g, the other constituents of the formulation were recalculated accordingly.

For foaming, the polyol, water, amine, tin catalyst and silicone stabilizer were thoroughly mixed under agitation. Following simultaneous addition of methylene chloride and isocyanate, the mixture was stirred at 2500 rpm with a stirrer for 7 seconds. The mixture obtained was poured into a paper-lined wooden box (base area 27 cm×27 cm). A foamed material was formed and subjected to the performance tests described hereinbelow.

For comparison, low-density foams were produced using a conventional stabilizer which was entirely suitable for foaming in low densities, but merely included polyethers with molecular weight<4000 g/mol.

### Example 3

### Physical Properties of Foams

The foams obtained in Example 2 were evaluated by the following physical properties:
a) Rise time:
   time difference between pouring in the starting mixture and blowing off the polyurethane foam.
b) Sagging of foam at end of rise period (=fall-back):
   Fall-back or conversely post-rise was obtained from the difference in foam height after direct blow-off and after 3 min after blowing off the foam. Foam height was measured using a needle secured to a centimetre scale, on the peak in the middle of the foam crust.
c) Foam height:
   The final height of the foam was determined by subtracting the fall-back from or adding the post-rise to the foam height after blow-off.
d) Cell structure:
   A horizontal foam disc 0.8 cm in thickness was cut out at a point 10 cm from the base of the foam body and visually compared with five standard foam discs having various cell structure qualities. A characterization of 1 describes substantial coarsening particularly in the edge region, while a characterization of 5 represents a uniform, fine cell.

The results are summarized in Table 3.

TABLE 3
Results for Example 3

| | Rise time | Fall-back | Foam height | Cell structure |
|---|---|---|---|---|
| Stabilizer | [s] | [cm] | [cm] | assessment |
| B 8110 | 90 | 2.6 | 33.8 | 2-3 |
| 1.1 | 92 | 1.0 | 37.1 | 3-4 |
| 1.2 | 95 | 1.2 | 36.7 | 4-5 |
| V.1 | 101 | 1.0 | 35.9 | 3 |
| V.2 | 94 | 0.1 | 37.5 | 3-4 |
| V.3 | 110 | 1.1 | 33.4 | 2-3 |
| V.4 | 117 | — | — | Collapse |

As is evident from Table 3, cell structure improves dramatically using foam stabilizers with weight average molecular weight>3000 g/mol (stabilizer as per Example 1.1 or 1.2). The use of polyethers having a molecular weight around 8000 g/mol made it possible to prepare stabilizers which appreciably improve foam quality and obtained a rating of 4 to 5. In addition, the fall-back of the foam was dramatically reduced when using long-chain polyethers, which gave a better foam yield as a result. This likewise points to an improved stabilization property of the novel structures particularly for foaming in low density.

### Example 4

### Production of Polyurethane Packaging Foam

The performance comparison of inventive and conventional foam stabilizers was carried out using the polyurethane packaging foam formulation indicated in Table 4.

TABLE 4
Formulations of packaging foam

| | Use level | |
|---|---|---|
| Component | (parts by mass) | |
| Daltolac R 251* | 52 | parts |
| Voranol CP 3322** | 23 | parts |
| Desmophen PU 21IK01*** | 20 | parts |
| polyethylene glycol 600 | 5 | parts |
| N,N-dimethylaminoethoxyethanol | 2.5 | parts |
| Water | 35 | parts |
| foam stabilizer | 1 | part |
| Desmodur 44V20L^{‡‡} | 226 | parts |

polyether polyol from Huntsman
**polyether polyol from DOW
***polyether polyol from Bayer
^{‡‡}polymeric MDI from Bayer, 200 mPa * s, 31.5% NCO, functionality 2.7

The comparative foamings were carried out by hand mixing. To this end, polyols, catalysts, water, cell openers and conventional or inventive foam stabilizer were weighed into a beaker and mixed together with a plate stirrer (6 cm diameter) at 1000 rpm for 30 s. The MDI was then added, the reaction mixture was stirred at 2500 rpm with the described stirrer for 5 s and immediately transferred into an upwardly open wooden box having a base area of 27 cm×27 cm and a height of 27 cm and lined with paper.

After 10 min., the foams were demoulded and analyzed. Cell structure was evaluated subjectively against a scale from 1 to 10, where 10 represents a very fine-cell and undisrupted foam and 1 represents a coarse, extremely disrupted foam. The percentage volume content of open cells was determined using an AccuPyc 1330 instrument from Micromeritics. Density was determined by weighing a 10 cm×10 cm×10 cm cube of the foam.

The foam stabilizers used and the related foaming results are collated in Table 5.

TABLE 5
Packaging foam results

| Stabilizer | Cell structure | Density [kg/m³] |
|---|---|---|
| Ex. 1.3 | 5 | 6.8 |
| B 8863Z* | 4 | 7.1 |

noninventive, comparative example; conventional foam stabilizer from Evonik Goldschmidt GmbH

The results show that the foam stabilizers of the present invention can be used to obtain polyurethane packaging foam having a good cell structure and comparatively few foam defects.

### Example 5

### Production of Sprayable Polyurethane Foam of Low Density

The performance comparison of inventive and conventional foam stabilizers was carried out using the purely water-driven sprayable lightweight foam formulation indicated in Table 6.

TABLE 6
Formulation of sprayable foam

| | Use level |
|---|---|
| Component | (parts by mass) |
| castor oil | 25.0 parts |
| Stepan PS 1922* | 7.5 parts |
| Jeffol R-470 X** | 7.0 parts |
| tris(1-chloro-2-propyl) phosphate | 20.0 parts |
| PHT-4-Diol*** | 10.0 parts |
| Tegoamine BDE^{‡} | 3.0 parts |
| Tegoamine 33^{‡} | 2.5 parts |
| Tegoamine DMEA^{‡} | 3.0 parts |
| water | 19.0 parts |
| stabilizer | 3.0 parts |
| Rubinate M^{‡‡} | 100 parts |

polyester polyol from Stepan
**Mannich base-initiated polyether polyol from Huntsman
***flame retardant from Chemtura
^{‡}amine catalysts from Evonik Goldschmidt GmbH
^{‡‡}polymeric MDI from Huntsman, 190 mPa * s, 31.2% NCO, functionality 2.7

The comparative foamings were carried out by hand mixing. To this end, polyols, catalysts, water, flame retardant and conventional/inventive foam stabilizer were weighed into a beaker and mixed together with a plate stirrer (6 cm diameter) at 1000 rpm for 30 s. The MDI was then added, the reaction mixture was stirred at 3000 rpm with the stirrer described for 2 s and the foam was subsequently allowed to rise in the mixing beaker.

After a 10 min full-cure time, the foam was analyzed. Cell structure was rated subjectively on a scale from 1 to 10, where 10 represents a very fine-cell and undisrupted foam and 1 represents a coarse, extremely disrupted foam. The percentage volume of open cells was determined using an AccuPyc 1330 instrument from Micromeritics. Density was determined by weighing a 10 cm×10 cm×10 cm cube of the foam.

All foam stabilizers used and the related foaming results are collated in Table 7.

TABLE 7
Results of sprayable foams

| | | Open cells | Density |
|---|---|---|---|
| Stabilizer | Cell structure | [%] | [kg/m³] |
| Ex. 1.3 | 8 | 84 | 9.3 |
| B 1048* | 7 | 88 | 11.1 |

noninventive, comparative example; conventional foam stabilizer from Evonik Goldschmidt

The foam stabilizer of the present invention gave a lower foam density and a better cell structure for the same open-cell content, manifesting the high activity of the foam stabilizers of the present invention.

While the present disclosure has been particularly shown and described with respect to preferred embodiments thereof, it will be understood by those skilled in the art that the foregoing and other changes in forms and details may be made without departing from the spirit and scope of the present disclosure. It is therefore intended that the present disclosure not be limited to the exact forms and details described and illustrated, but fall within the scope of the appended claims.

What is claimed is:

1. A silicone-polyether block copolymer comprising a polyorganosiloxane comprising at least one polyether residue having a weight average molecular weight of not less than 5000 g/mol, and wherein a weight average molecular weight of all polyether residues attached to the polyorganosiloxane by a chemical bond is above 3000 g/mol.

2. The silicone-polyether block copolymer according to claim 1, wherein said at least one polyether residue having a weight average molecular weight of not less than 5000 g/mol and at least one other polyether residue having a weight average molecular weight of below 5000 g/mol are attached to the polyorganosiloxane by a chemical bond.

3. The silicone-polyether block copolymer according to claim 1, wherein the weight average molecular weight of all polyether residues attached to the polyorganosiloxane by the chemical bond is above 3000 g/mol and below 5000 g/mol.

4. The silicone-polyether block copolymer according to claim 1, wherein said silicone-polyether block copolymer is of a structure of formula (I) 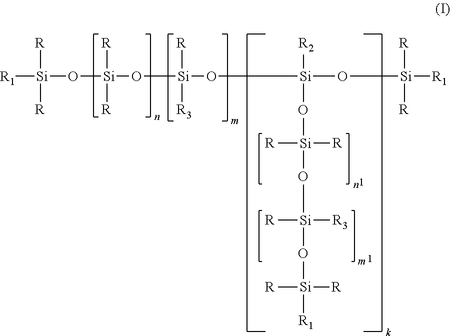
where
n and n¹ are each independently from 0 to 500 and (n+n¹) is <500,
m and m¹ are each independently from 0 to 60 and (m+m¹) is <60,
k is from 0 to 50,
R represents alike or unalike radicals selected from the group consisting of linear, cyclic or branched, aliphatic or aromatic, saturated or unsaturated hydrocarbon radicals having from 1 up to 20 carbon atoms, 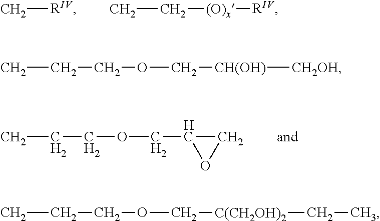
where
x′ is 0 or 1 and
R^{IV} is an optionally substituted, optionally halogen-substituted hydrocarbon radical having 1 to 50 carbon atoms,
R₁ is R or R₃,
R₂ is R or R₃ or a heteroatom-substituted, functional, organic, saturated or unsaturated radical,
R₃ is -Q-O—(CH₂—CH₂O—)ₓ—(CH₂—CH(R′)O—)_{y}—(SO)_{z}—R″
or
-Q-O—(CH₂—CH₂O—)ₓ—(CH₂—CH(R′)O—)_{y}—R″,
where
Q=divalent hydrocarbon radical having 2 to 4 carbon atoms, x=0 to 200,
y=0 to 200,
z=0 to 100,
R′ is an alkyl or aryl group which has 1 to 12 carbon atoms and is unsubstituted or optionally substituted, and
R″ is a hydrogen radical or an alkyl group having 1 to 4 carbon atoms, a —C(O)—R′″ group where R′″=alkyl, a —CH₂—O—R′ group, an alkylaryl group, or a —C(O)NH—R′ group,
SO is a styrene oxide radical —CH(C₆H₅)—CH₂—O—,
with the proviso that at least one radical is an R₃ radical and that at least one R₃ radical is a polyether residue having a weight average molecular weight not less than 5000 g/mol and the weight average molecular weight of all polyether residues R₃ in the copolymer of formula (I) is more than 3000 g/mol, and n+n¹+m+m¹ is not less than 15.

5. The silicone-polyether copolymer according to claim 4, wherein R″ is hydrogen for all polyether residues R₃ having a weight average molecular weight not less than 5000 g/mol.

6. The silicone-polyether copolymer according to claim 4 wherein R″ is other than hydrogen for all polyether residues R₃ having a weight average molecular weight below 5000 g/mol.

7. A process for production of a silicone-polyether block copolymer comprising: reacting a branched or linear polyorganosiloxane having terminal and/or lateral SiH functions with a polyether or polyether mixture of two or more polyethers, wherein the polyether used or the polyether mixture used includes at least one polyether having a molecular weight not less than 5000 g/mol and an average molecular weight of all polyethers used is above 3000 g/mol.

8. A composition comprising the silicon-polyether copolymer according to claim 1 and one or more substances useful in polyurethane foam production and selected from nucleating agents, cell-refining additives, cell openers, crosslinkers, chain extenders, emulsifiers, flame retardants, antioxidants, UV stabilizers, antistats, biocides, color pastes, solid fillers, amine catalysts, metal catalysts and buffer substances.

9. The composition according to claim 8, further comprising one or more solvents.

10. A method for the production of a polyurethane foam comprising: reacting a silicone-polyether block copolymer with at least a polyol and a diisocyanate, wherein said silicone-polyether block copolymer comprises a polyorganosiloxane comprising at least one polyether residue having a weight average molecular weight of not less than 5000 g/mol, and wherein a weight average molecular weight of all polyether residues attached to the polyorganosiloxane by a chemical bond is above 3000 g/mol.

11. The method according to claim 10, wherein the silicone-polyether block copolymer is used as a foam stabilizer.

12. The method according to claim 10, further comprising a blowing agent selected from the group consisting of water, methylene chloride, pentane, alkane, halogenated alkane, acetone and carbon dioxide.
